(19) United States
(12) Patent Application Publication
(10) Pub. No.: US 2002/0120868 A1
(43) Pub. Date: Aug. 29, 2002

(54) Method and apparatus for dynamic server provisioning

(76) Inventor: Russell C. Hay, Kirkland, WA (US)

Correspondence Address: PARK, VAUGHAN & FLEMING LLP, 508 SECOND STREET, SUITE 201, DAVIS, CA, 95616, US

(21) Appl. No.: 09/796,312

(22) Filed: Feb. 27, 2001

(51) Int. Cl. G06F 11/30

(52) U.S. Cl. 713/201

(57) ABSTRACT

One embodiment of the present invention provides a system for dynamic server provisioning, wherein a number of functions are made available through use of loadable modules. The system operates by first receiving an account configuration file specifying modules that an account holder is authorized to access. The system then reads the account configuration file to determine a module allowed for the specific account. After determining an allowed module, the system next recovers a verb table from the allowed module that contains a list of commands available within the allowed module. This verb table is stored in a master verb table which specifies every command authorized for the account holder. Additionally, the master verb table relates verbs to the allowed module. The system next accepts a command from a user. After accepting the command, the system validates the command by looking up the command in the master verb table. If the command is valid, the system executes the command by calling a corresponding function within the allowed module.

### BACKGROUND

1. Field of the Invention

The present invention relates to managing computer servers. More specifically, the present invention relates to a method and apparatus for facilitating a secure method for remotely establishing and maintaining accounts on servers.

2. Related Art

The desire to present information and services on the World Wide Web has led to the proliferation servers to supply the necessary computational power, storage, and communications bandwidth. This, in turn, has led to the creation of hosting companies which supply servers to host web sites and other applications for individuals and small entities without the resources to establish their own servers.

One method of establishing and maintaining accounts on the servers is to physically access the server. While this method is secure, it is impractical because of the number of servers and clients involved and because access to the server can be limited by distance or other physical impediments.

A more practical method of establishing and maintaining accounts on the servers is to access the server across a network such as the Internet. While access across a network alleviates the need for physical access to the server, such access creates problems in maintaining security for both the server owner and the server user.

When an account is established on a server, the account holder is typically given access to modules that include functions that are used to maintain the content stored on the server. Many of these functions are command scripts that run on the server at system privilege levels, and therefore can be easily exploited for illicit purposes by unscrupulous account holders.

A server user needs to be assured that other server users can not change the stored content, and that access to the stored content by end-users can be controlled. Likewise, the server owner needs to be assured that a server user cannot, either maliciously or accidentally, alter the operating environment of the server.

What is needed is a method and an apparatus to allow efficient remote account establishment and maintenance of accounts on servers while eliminating the problems listed above.

### SUMMARY

One embodiment of the present invention provides a system for dynamic server provisioning, wherein a number of functions are made available through use of loadable modules. The system operates by first receiving an account configuration file specifying modules that an account holder is authorized to access. The system then reads the account configuration file to determine a module allowed for the specific account. After determining an allowed module, the system next recovers a verb table from the allowed module that contains a list of commands available within the allowed module. This verb table is stored in a master verb table which specifies every command authorized for the account holder. Additionally, the master verb table relates verbs to the allowed module. The system next accepts a command from a user. After accepting the command, the system validates the command by looking up the command in the master verb table. If the command is valid, the system executes the command by calling a corresponding function within the allowed module.

In one embodiment of the present invention, the system receives the account configuration file across an encrypted link on a network.

In one embodiment of the present invention, while accepting the command from the user, the system determines if the command originated from an authorized internet protocol (IP) address. If the command did not originate from an authorized IP address, the system logs an IP error.

In one embodiment of the present invention, while accepting the command from the user the system reads a password associated with the command. Next, the system verifies the password. If the password is not correct, the system logs a password error.

In one embodiment of the present invention, the system validates the command by locating the command in the master verb table. If the command is not in the master verb table, the system logs a command error

In one embodiment of the present invention, the system validates the command by scanning an argument string associated with the command to check for disallowed characters. If the argument string contains disallowed characters, the system logs an argument error.

In one embodiment of the present invention, the system repeats the steps of accepting, validating, and executing commands until the process is terminated.

### BRIEF DESCRIPTION OF THE FIGURES

FIG. 1 illustrates computing devices coupled together in accordance with an embodiment of the present invention.

FIG. 2 illustrates some of the data items associated with representative server 118 in accordance with an embodiment of the present invention.

FIG. 3 is a flowchart illustrating the process of reading a configuration file and accessing the verb table in accordance with an embodiment of the present invention.

FIG. 4 is a flowchart illustrating the process of accepting and validating a command in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

### Computing Devices

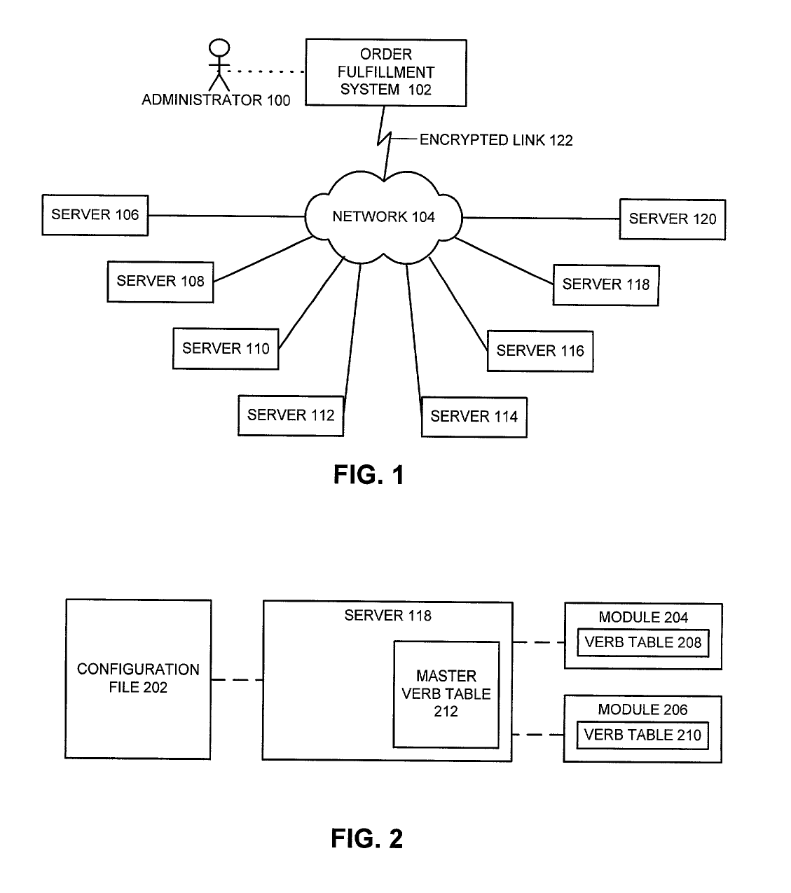

FIG. 1 illustrates computing devices coupled together in accordance with an embodiment of the present invention. The system illustrated in FIG. 1 includes order fulfillment system 102 and servers 106, 108, 110, 112, 114, 116, 118, and 120. Order fulfillment system 102 and servers 106, 108, 110, 112, 114, 116, 118, and 120 can generally include any type of computer system, including, but not limited to, a computer system based on a microprocessor, a mainframe computer, a digital signal processor, a portable computing device, a personal organizer, a device controller, and a computational engine within an appliance. In one embodiment of the present invention, order fulfillment system 102 is a desktop personal computer, while servers 106, 108, 110, 112, 114, 116, 118, and 120 are virtual servers hosted on one or more general purpose computing devices. In general, the system is not restricted to eight servers and may include any number of servers.

In operation, administrator 100 uses order fulfillment system 102 to establish accounts and authorize access to servers 106, 108, 110, 112, 114, 116, 118, and 120. Order fulfillment system 102 communicates a configuration file to one of servers 106, 108, 110, 112, 114, 116, 118, or 120. Details of the configuration file are described below in conjunction with FIG. 2. Communications between order fulfillment system 102 and servers 106, 108, 110, 112, 114, 116, 118, and 120 are established through encrypted link 122 to ensure privacy and to allow detection of tampering.

Communications between order fulfillment system 102 and servers 106, 108, 110, 112, 114, 116, 118, and 120 are established through network 104. Network 104 can generally include any type of wire or wireless communication channel capable of coupling together computing nodes. This includes, but is not limited to, a local area network, a wide area network, or a combination of networks. In one embodiment of the present invention, network 104 includes the Internet.

### Data Items Associated with a Server

FIG. 2 illustrates some of the data items associated with representative server 118 in accordance with an embodiment of the present invention. During operation, a server, such as server 118, receives configuration file 202 from order fulfillment system 102. Server 118 reads configuration file 202 to determine a list of modules being authorized for the account. In this example, configuration file 202 includes modules 204 and 206, however, this is not meant to limit the system to two modules. In fact, any number of modules can be listed within configuration file 202.

Included within modules 204 and 206 are verb tables 208 and 210 respectively. Verb table 208 lists all of the verbs or commands available in module 204, while verb table 210 lists all of the verbs or commands available in module 206.

In operation, server 118 gathers the verbs from all of the verb tables within the modules listed in configuration file 202 and saves the verbs in master verb table 212. For each verb, master verb table 212 stores the verb and the name of the module containing the verb, so that server 118 can locate the correct module when processing the verb.

### Reading the Configuration File

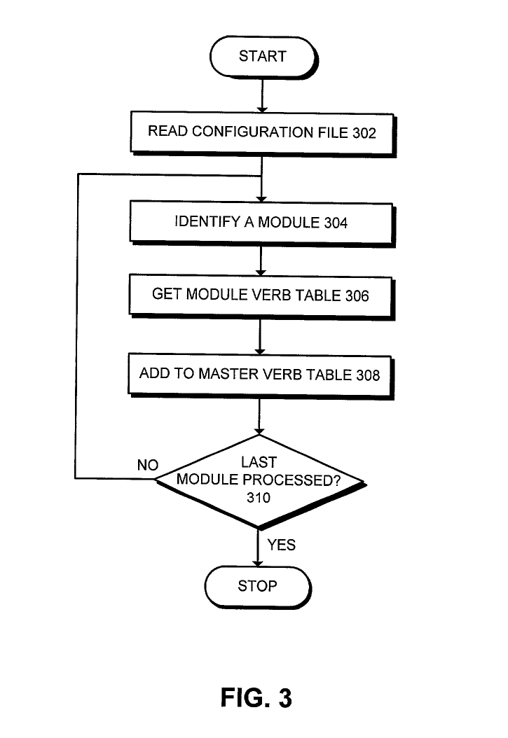

FIG. 3 is a flowchart illustrating the process of reading a configuration file and accessing the verb table in accordance with an embodiment of the present invention. The system starts when a server, such as server 118, reads configuration file 202 (302). Next, server 118 identifies a module, for example module 204, listed in configuration file 202 (304). Server 118 then reads verb table 208 located in module 204 (306). After reading verb table 208 located in module 204, server 118 stores the verbs from verb table 208 within master verb table 212 (308). Server 118 then determines if the last module listed in configuration file 202 has been processed (310). If the last module listed in configuration file 202 has not been processed, server 118 returns to 304 and repeats the process described above. Otherwise, the process is terminated.

### Validating a Command

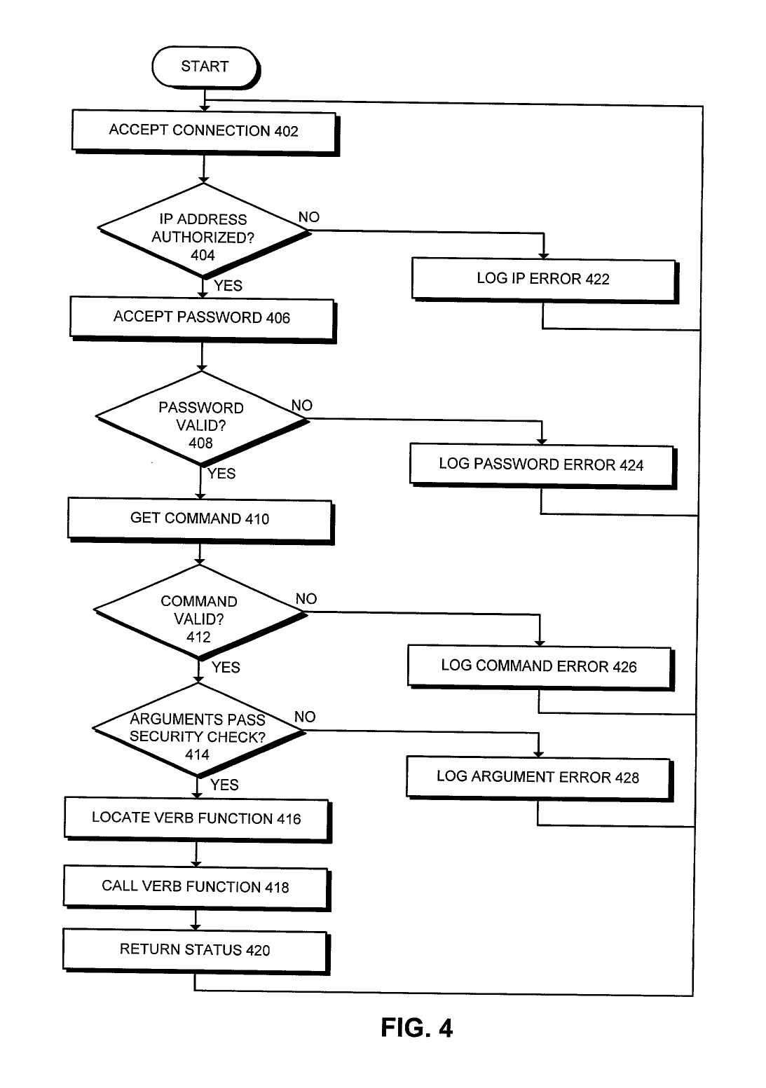

FIG. 4 is a flowchart illustrating the process of accepting and validating a command in accordance with an embodiment of the present invention. The system starts when a server, for example server 118, accepts a connection from network 104 (402). Server 118 then determines if the connection originated from an authorized Internet Protocol (IP) address (404). If the connection did not originate from an authorized IP address, server 118 logs an IP error and the process returns to 402 to accept another connection (422).

If the connection originated from an authorized IP address, server 118 accepts a password from the incoming connection (406). Next, server 118 checks the validity of the password (408). If the password is not a valid password, server 118 logs a password error and the process returns to 402 to accept another connection (424).

If the password is valid, server 118 gets a command from the incoming connection (410). Next, server 118 determines if the command is a valid command by referring to master verb table 212 (412). If the command is not a valid command, server 118 logs a command error and the process returns to 402 to accept another connection (426).

If the command is a valid command, server 118 scans an argument string associated with the command to determine if the argument string contains any characters that would pose a security risk if passed to the operating system of server 118 (414). Examples of characters that would pose a security risk include the semicolon (;), backslash (●), and the grave accent (`). If the argument string contains any characters that would pose a security risk, server 118 logs an argument error and the process returns to 402 to accept another connection (428).

If the argument string does not contain any characters that would pose a security risk, server 118 locates the verb function in the associated module (416). Next, server 118 calls the verb function within the associated module to execute the command (418). After executing the command, server 118 returns the status of the command (420). Finally, the process returns to 402 to accept another connection.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for dynamic server provisioning, wherein a number of functions are made available through use of loadable modules, comprising:
receiving an account configuration file specifying modules that an account holder is authorized to access;
reading the account configuration file to determine an allowed module that the account holder is authorized to access;
recovering a verb table from the allowed module, wherein the verb table contains a list of commands available in the allowed module;
storing the verb table in a master verb table which specifies every command authorized for the account holder, wherein the master verb table relates a verb to the allowed module;
accepting a command from a user;
validating the command using the master verb table; and
if the command is valid, executing the command by calling a corresponding function within the allowed module.

2. The method of claim 1, further comprising receiving the account configuration file across an encrypted link on a network.

3. The method of claim 1, wherein accepting the command from the user includes:
determining if the command originated from an authorized internet protocol (IP) address; and
if the command did not originate from the authorized IP address, logging an IP error.

4. The method of claim 1, wherein accepting the command from the user includes:
reading a password associated with the command;
verifying the password; and
if the password is not correct, logging a password error.

5. The method of claim 1, wherein validating the command includes:
locating the command in the master verb table; and
if the command is not in the master verb table, logging a command error.

6. The method of claim 1, wherein validating the command includes:
scanning an argument string associated with the command to check for disallowed characters; and
if the argument string contains disallowed characters, logging an argument error.

7. The method of claim 1, further comprising repeating the steps of accepting, validating, and executing until the method is terminated.

8. A computer-readable storage medium storing instructions that when executed by a computer cause the computer to perform a method for dynamic server provisioning, wherein a number of functions are made available through use of loadable modules, the method comprising:
receiving an account configuration file specifying modules that an account holder is authorized to access;
reading the account configuration file to determine an allowed module that the account holder is authorized to access;
recovering a verb table from the allowed module, wherein the verb table contains a list of commands available in the allowed module;
storing the verb table in a master verb table which specifies every command authorized for the account holder, wherein the master verb table relates a verb to the allowed module;
accepting a command from a user;
validating the command using the master verb table; and
if the command is valid, executing the command by calling a corresponding function within the allowed module.

9. The computer-readable storage medium of claim 8, the method further comprises receiving the account configuration file across an encrypted link on a network.

10. The computer-readable storage medium of claim 8, wherein accepting the command from the user includes:
determining if the command originated from an authorized internet protocol (IP) address; and
if the command did not originate from the authorized IP address, logging an IP error.

11. The computer-readable storage medium of claim 8, wherein accepting the command from the user includes:
reading a password associated with the command;
verifying the password; and
if the password is not correct, logging a password error.

12. The computer-readable storage medium of claim 8, wherein validating the command includes:
locating the command in the master verb table; and
if the command is not in the master verb table, logging a command error.

13. The computer-readable storage medium of claim 8, wherein validating the command includes:
scanning an argument string associated with the command to check for disallowed characters; and
if the argument string contains disallowed characters, logging an argument error.

14. The computer-readable storage medium of claim 8, the method further comprises repeating the steps of accepting, validating, and executing until the method is terminated.

15. An apparatus that facilitates dynamic server provisioning, wherein a number of functions are made available through use of loadable modules, comprising:
a receiving mechanism that is configured to receive an account configuration file specifying modules that an account holder is authorized to access;
a reading mechanism that is configured to read the account configuration file to determine an allowed module;
a recovering mechanism that is configured to recover a verb table from the allowed module, wherein the verb table contains a list of commands available in the allowed module;
a storing mechanism that is configured to store the verb table in a master verb table which specifies every command authorized for the account holder, wherein the master verb table relates a verb to the allowed module;
an accepting mechanism that is configured to accept a command from a user;
a validating mechanism that is configured to validate the command using the master verb table; and
an executing mechanism that is configured to execute the command by calling a corresponding function within the allowed module if the command is valid.

16. The apparatus of claim 15, wherein the receiving mechanism is configured to receive the account configuration file across an encrypted link on a network.

17. The apparatus of claim 15, further comprising:
a determining mechanism that is configured to determine if the command originated from an authorized internet protocol (IP) address; and
an error logging mechanism that is configured to log an IP error if the command did not originate from an authorized IP address.

18. The apparatus of claim 15, further comprising:
a password reading mechanism that is configured to re ad a password associated with the command;
a password verifying mechanism that is configured to verify the password; and
a password error logging mechanism that is configured to log a password error if the password does not verify as correct.

19. The apparatus of claim 15, further comprising:
a locating mechanism that is configured to locate the command in the master verb table; and
a command error logging mechanism that is configured to log a command error if the command is not in the master verb table.

20. The apparatus of claim 15, further comprising:
a scanning mechanism that is configured to scan an argument string associated with the command to check for disallowed characters; and
an argument logging mechanism that is configured to log an argument error if the argument string contains disallowed characters.

21. The apparatus of claim 15, further comprising a repeating mechanism that is configured to repeat the steps of accepting, validating, and executing until manually stopped.
